(19) United States
(12) Patent Application Publication
(10) Pub. No.: US 2008/0115733 A1
(43) Pub. Date: May 22, 2008

(54) ANIMAL BEDDING AND METHOD OF MANUFACTURE

(75) Inventor: Marty Johnes, Godfrey, IL (US)

Correspondence Address: HUSCH BLACKWELL SANDERS LLP, 720 OLIVE STREET, SUITE 2400, ST. LOUIS, MO, 63101, US

(73) Assignee: ALFA-PET, INC., St. Louis, MO (US)

(21) Appl. No.: 11/562,004

(22) Filed: Nov. 21, 2006

(51) Int. Cl. A01K 29/00

(52) U.S. Cl. 119/172; 83/29

(57) ABSTRACT

A cellulose based animal bedding material is provided. The bedding is in the form of multi layered clumps with the layers being bound together by interaction between side margin portions of the clumps. The cutting process of the paper affects the adherence of the layers in the clumps together. The clumps may be packaged for shipping and handling. The clumps may then be dispensed to an animal bed as desired. Deodorized materials may be incorporated into the clumps.

### BACKGROUND OF THE INVENTION

Various types of animal bedding are well known in the industry. They range from quilted and filled blankets to sawdust to clay materials. Some of the bedding is meant to be semi-permanent and some is meant to be disposable. A common form of disposable bedding is cellulose based. Examples of bedding litter can be found in U.S. Pat. No. 6,991,783, corrugated cardboard, U.S. Pat. No. 4,619,862, pillows and other forms and U.S. Pat. No. 5,964,188 strips. Bedding can also take the form of folded and crumpled paper, for example, newspaper, sawdust or the like. The bedding material can be coated and/or impregnated with an odor control material, for example, baking soda in various forms. For bedding materials usable with pets that are allowed to roam a home or other building, it is desirable to have the bedding material configured that it will not adhere to the animal, either its fur, feathers or feet, to be tracked through the home or building. To do this, either the bedding must be large such that its weight will preclude adhesion for any period of time usually necessitating a uniformity in size of particles, i.e., few if any small particles. It is also desirable to have the bedding material of low density in order to reduce the cost and weight. It is also desirable to have the bedding material absorbent and partially replaceable in the event the pet deposits waste material on the bedding material to facilitate cleaning of the bedding area.

Sawdust has been a somewhat effective bedding material for both large and small animals, but is very dense and typically of non uniform particle size and often times has projecting points, that induce adhesion to an animal's fur or feathers. Sawdust has high density and its absorbency is somewhat limited. Sawdust is also relatively hard in bulk. Wood shavings are also used.

Processed cellulose based animal bedding would be desirable because of its low cost. It can be made from waste or recycled products, and can be made relatively absorbent and resilient. It would therefore be desirable to provide cellulose based bedding material that is of low density, resiliently compressible for packaging and shipping and can be made from either waste or manufactured materials to provide the appropriate normal bulk density and packaged bulk density.

### SUMMARY OF THE INVENTION

The present invention involves the provision of animal bedding that is in the form of a plurality of clumps. The clumps include a plurality of layers of paper cohered together at cut edge margin portions. The clumps include a plurality of layers of paper and have a length of at least about ⅛ inch (0.30 cm) and a width of at least about 1/16 inch (0.15 cm). The clumps have a normal bulk density of less than about 90 g/liter.

The present invention also involves the provision of a method of making animal bedding from cellulosic material. The method involves providing a plurality of layers of paper in a stack. The stacks include at least about 8 layers of paper. The stack of paper sheets is cut with a first cutter in a first direction with the cutter passing through the stack of paper. The stack of paper is cut in a second direction with a second cutter with the second cutter also passing through the stack of paper to form discrete multilayered clumps of cohered layers of paper. The clumps have a length of at least about ⅛ inch (0.30 cm) and a width of at least about 1/16 inch (0.15 cm). The layers of the cut paper are bound together in the clump or pellet form by interengagement of cut edge margin portions of at least some of the layers of paper in each clump. The formed clumps may then be packaged. The packaged clumps are then used by placing clumps from the package in a container accessible by an animal.

### BRIEF DESCRIPTION OF THE DRAWINGS

FIG. 1 is an enlarged perspective view of a formed clump of bedding material made from a plurality of layers of paper.

FIG. 2 is a schematic perspective illustration of a manufacturing line for forming the clumps of paper material.

Like numbers throughout the various Figures designate like or similar parts and/or construction.

### DETAILED DESCRIPTION

The reference numeral 1 designates generally a clump or pellet which is shown as being generally rectangular in shape having a length L and a width W. The clumps 1 may have folds and bends from the forming process, and as straightened would be generally rectangular. The dimensions provided herein are those for the straightened clumps. The opposing longitudinal sides 2, 3 are preferably generally parallel and the opposing ends 4, 5 are also preferably generally parallel. The clump 1 is comprised of a plurality of layers 7 to form a stack of layers in superposed relationship. The layers 7 are formed of sheets of paper or other appropriate cellulosic material that are in generally concentric and/or parallel relationship with one another in a clump 1, i.e., their transverse planes and outer main surfaces are generally concentric and/or parallel. The sides and ends 2-5 are formed by cutting as described below. A plurality of clumps 1 when combined loosely in a container provide a normal (uncompressed) bulk density of less than about 90 g/liter and more preferably in the range of between about 50 g/liter and about 90 g/liter. The normal bulk density may be measured by pouring a quantity of clumps 1, for example, one pound into a container, measuring the volume occupied by the clumps including the interstitial space in the container and dividing the weight by the volume. Preferably, the layers 7 of paper can be of any suitable type of paper but preferably have a slightly napped surface to help reduce the density and to provide resilient compressibility. The paper preferably is non-calendared or lightly calendared, has appropriate crepe and has a felt side and a wire side from the paper manufacturing process. Any suitable type of paper can be used and is preferably no more than lightly coated or uncoated, no more than lightly filled or unfilled, bleached or unbleached, has short fiber and/or heavily beaten and can include paper such as napkin, toilet and tissue type paper. The paper may include some clay fillers for appearance, other additives, colorants and deodorizing agents such as baking soda. Preferably, the paper is a type that will form ragged or jagged edges when cut as described below. The central region 11 between the layers 7 is unbound which allows for resilient compression and expansion as well as flexibility of the finished clumps 1. The layers 7 are bound together by the cutting process by what is believed to be interengagement of exposed fibers at the marginal edge portions at the sides and ends 2-5 of the clumps 1. In a preferred embodiment, it is preferred to have at least about 20 layers 7 of paper. It is to be understood that layers 7 may be multi ply but the described number of layers includes all layers. Preferably the number of layers 7 is in the range of between about 25 and about 75 and more preferably in the range of between about 40 and about 60. The thickness of the paper layer 7 prior to cutting is in the range of between about 0.001 inches (0.002 cm) and 0.005 inches (0.012 cm). This will provide a clump with a normal height H (uncompressed after clump formation) preferably in the range of between about 1/16 inch (0.15 cm) and about ½ inch (1.25 cm) and more preferably in the range of between about 3/32 inch (0.24 cm) and about ⅜ inch (0.95 cm) most preferably about ¼ inch (0.6 cm). If too many layers are provided, the clump may separate between paper layers into multiple clumps. It has been found that the layers 7 do not cohere well to one another if too few layers of paper are used, binding between the various layers is inhibited and the clumps become more like loose paper pieces than clumps. The length L (straightened out) of the clumps 1 is in the range of between about ⅛ inch (0.30 cm) and about 2½ inches (6.3 cm) and preferably in the range of between about ¼ inch (0.6 cm) and about 2 inches (5 cm) and more preferably in the range of between about ½ inch (1.2 cm) and about 2 inches (5 cm). The width W (as straightened out) of the clumps 1 is in the range of between about 1/16 inch (0.15 cm) and about ½ inch (1.2 cm) and most preferably in the range of between about ⅛ inch (0.30 cm) and about ⅜ inch (0.95 cm).

The clumps 1 are preferably packaged in a package 20 as seen in FIG. 2 and are preferably compressed to reduce the volume from normal for shipping and handling. The package 20 can be in the form of a paper or plastic bag or a rigid container, for example, a paperboard box. As packaged, the clumps 1 have a bulk density of at least about 175 g/liter preferably in the range of between about 200 g/liter and about 300 g/liter more preferably in the range of between about 210 g/liter and about 270 g/liter and most preferably in the range of between about 220 g/liter and about 250 g/liter. For use, the clumps 1 are removed from the container 20 and poured or sprinkled into a container 25 such as an animal bed which may be in the form of an open top container or a container with a cage for confinement of an animal therein.

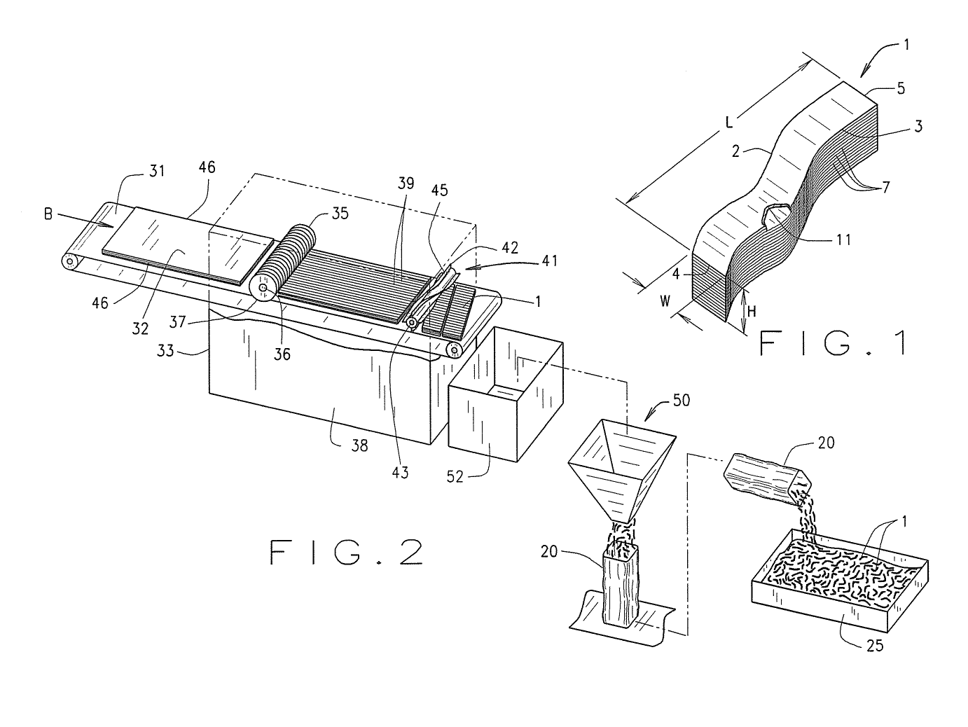

FIG. 2 is a schematic illustration of an apparatus for making the clumps 1 as seen in FIG. 1. Sheets 31 of paper are placed one on top of one of the other to provide a stack 32. The stack 32 is fed into a cutting apparatus 33 such as a shredding machine. The central transverse planes of the sheets 31 of paper are preferably in generally parallel relationship or concentric (including parallel) relationship and in superposed relationship in the stack 32. The number of layers 31 of paper correspond to the number of layers 7 of paper in the clump 1. In a preferred embodiment, the sheets 31 of paper first encounter first cutters 35, preferably rotary disc cutters, which are positioned across the width of the sheets 31 of paper and are mounted to a shaft 36 which in turn is operably connected to a power drive device such as an electric motor. The cutters 35 are in spaced apart relationship corresponding to the width W of the clumps 1. The diameter of the rotating cutters is sufficient to pass completely through the layers 31 of paper. The speed of the outer perimeter 37 of the cutters 35 exceeds the speed of the layers 31 passing through the apparatus 33. The layers or sheets 31 may be fed by suitable conveyor means such as conveyor belts, corrugated drive rolls or the like. If belts are used under cutters 35, they are in laterally spaced relationship or are grooved to provide clearance for the cutters 35. The layers 31 may also be fed by gravity and/or by friction with the cutters 35. The layers 31 move through the machine 33 in a longitudinal direction as designated by the arrow B. Such rotary cutting systems are well known in the art. A preferred machine 33 is a IPS Combo machine available from Industrial Paper Shredder located at Salem, Ohio. Some dust and cuttings will be generated by the cutters 35 and may be collected in the base 38 of the machine 33. Upon exiting the cutter station where the cutters 35 are located, the sheets 31 of paper are now in elongate narrow strips 39. The strips 39 are then fed to a second cutter 47 for cross cutting the strips to finish forming the clumps 1. A preferred cutter 41 can be a series of cutter bars 42 mounted to an axle 43 which in turn is connected to a power drive device such as an electric motor for revolving the cutter bars 42 about the axis of revolution of the bars 42 and the axis of rotation of the shaft 43. The outer disposed edges 45 of the bars 42 are sharpened whereby the sharpened edges 45 pass through the strips 39 of paper fed thereto to sever the strips of paper into the clumps 1 most having four cut sides. The outside edges 46 of the sheets 31 need not be cut. The cutter bars 42 are spaced to provide the desired length L. The cutters 35, 42 preferably compress the layers 37 during cutting to help effect coherence between the layers 7. The ends 4, 5 are generally perpendicular to the sides 2, 3. Although this angular relationship is not critical, it can be as much as 45° off from perpendicular to the sides 2, 3 and for purposes of this invention be considered generally perpendicular. However, the more the deviation is from normal, the more paper width has to be cut and the longer the bars and the more work needed to cut the paper strips. By selection of the speed of the cutters 35 when the cutters 35 sever the layers of paper 31, fibers from adjacent layers bond by what is believed to be intertwining fibers to bind the layers 7 together to form the clumps 1 without having to use adhesive or other materials to effect mechanical or physical binding between the layers. Upon cross cutting, the clumps 1 may be transferred via a conveyor to a filling machine designated generally 50 or may be discharged into totes 52 for subsequent storage and/or transfer to a filling machine 50 depending upon the manufacturing line used. The clumps 1 are fed from the cutting machine 33 to the filling machine 50. The filling machine 50 deposits a pre-determined weight or volume quantity of clumps 1 into containers 20 and the containers are closed as with a twist tie, heat sealing or the like. Such depositing and filling machines are well known in the art. A satisfactory filling machine is a Premier HVS Bagger provided by Premier Tech Systems located at Quebec, Canada. As packed, the clumps 1 in the bag 20 have a packed density as described above.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. Animal bedding comprising;
a plurality of clumps, said clumps including a plurality of layers of paper self adhered together at cut edge margin portions thereof, said clumps including at least about 20 layers of paper and having a length of at least about ½ inch and a normal bulk density of less than about 90 g/liter.

2. The bedding of claim 1 wherein the clumps include layers of paper in the range of between about 25 and about 75 layers.

3. The bedding of claim 2 wherein a said layer of paper has thickness in the range of between about 0.001 inches and about 0.005 inches.

4. The bedding of claim 3 wherein the layers of paper include at least one of no more than lightly calendared, no more than lightly coated and no more than lightly filled types of paper.

5. The bedding of claim 3 wherein the clumps have a length in the range of between about ⅛ inch and about 2½ inches and width in the range of between about 1/16 inch and about ½ inch.

6. The bedding of claim 5 wherein the clump length is in the range of between about ¼ inch and about 2 inches and the clump width is in the range of between about ⅛ inch and about ⅜ inch.

7. The bedding of claim 1 wherein the clumps are contained in a package and the packaged bulk density of the clumps is at least about 175 g/liter.

8. The bedding of claim 1 wherein said plurality of clumps is contained in a quantity of clumps wherein said plurality of clumps comprises at least a majority by weight of said quantity of clumps.

9. The bedding of claim 3 wherein said number of layers of paper is in the range of between about 40 layers and about 60 layers.

10. A method of making animal bedding comprising:
providing a plurality of layers of paper in a stack, said stack including at least about 20 layers of paper;
cutting the stack of paper in a first direction with a first cutter passing through the stack;
cutting the stack of paper in a second direction with a second cutter passing through the stack to form clumps having a length of at least about ⅛ inch and a width of at least about 1/16 inch;
joining the layers in a clump together by at least interengagment of edge margin portions of at least some of the layers in each clump;
packaging the formed clumps; and
placing at least some of the clumps in an animal bed.

11. The method of claim 10 wherein the first direction of cutting being in a longitudinal direction of the stack and the second direction of cutting being in a direction generally normal to the first direction.

12. The method of claim 11 wherein the first cutter including a rotating wheel cutter.

13. The method of claim 12 wherein the second cutter including at least one revolving bar cutter.

14. The method of claim 13 wherein the bar being helically configured about an axis of revolution.

15. The method of claim 11 wherein the formed clumps having a normal bulk density of less than about 90 g/liter.

16. The method of claim 15 wherein the packaged formed clumps having a bulk density of at least about 175 g/liter.
